(19) United States
(12) Patent Application Publication
(10) Pub. No.: US 2025/0162440 A1
(43) Pub. Date: May 22, 2025

(54) SYSTEM FOR MANAGING VEHICLE CHARGING AND METHOD FOR THE SAME

(71) Applicant: CHINA MOTOR CORPORATION, Taipei (TW)

(72) Inventors: Bo-Yu GAO, Taipei (TW); Wei-Chung CHEN, Taipei (TW); Tzu-Hao CHEN, Taipei (TW)

(73) Assignee: CHINA MOTOR CORPORATION, Taipei (TW)

(21) Appl. No.: 18/396,890

(22) Filed: Dec. 27, 2023

(30) Foreign Application Priority Data
Nov. 16, 2023 (TW) 112144359

(51) Int. Cl. B60L 53/62; B60L 53/16; B60L 53/66; B60L 58/12

(52) U.S. Cl. CPC B60L 53/62; B60L 53/16; B60L 53/66; B60L 58/12; B60L 2240/547

(57) ABSTRACT

A system for managing vehicle charging adapted for a charging gun includes a communication bus, a battery, a sensor, an OBC, and a domain controller. The domain controller receives a first voltage and a second voltage that correspond to a current of charge to the battery from the sensor, and when determining that both the battery and the OBC are operating normally based on information received through the communication bus, notifies the OBC through the communication bus to start charging the battery with electricity received from the charging gun. When determining that an amount of charged power calculated using a calibrated voltage, which is obtained based on the first voltage or the second voltage, has reached a predetermined amount, the domain controller sends a stop message to the communication bus so as to notify the OBC to stop charging the battery.

### CROSS-REFERENCE TO RELATED APPLICATION

This application claims priority to Taiwanese Invention patent application No. 112144359, filed on Nov. 16, 2023, the entire disclosure of which is incorporated by reference herein.

### FIELD

The disclosure relates to a system for managing charging, and more particularly to a system for managing vehicle charging and a method for the same.

### BACKGROUND

Referring to FIG. 1, a conventional system for managing vehicle charging includes a communication bus 11, and further includes an electric vehicle battery 12, a battery management system (BMS) 13, a controller 14, and an on board charger (OBC) 15 that are electrically connected to the communication bus 11. The controller 14 is configured to notify the OBC 15 through the communication bus 11 to start charging the electric vehicle battery 12. During the charging process, the BMS 13 continuously monitors various battery statuses of the electric vehicle battery 12, and sends an amount of charged power and the battery statuses (e.g., operating normally or not) to the controller 14 through the communication bus 11. The controller 14 may then determine and notify the OBC 15 on whether to continue charging the electric vehicle battery 12 based on the information received.

The BMS 13 and the controller 14 of the conventional system for managing vehicle charging require exchanging information (e.g., the amount of charged power calculated by the BMS 13 based on a charging current magnitude) with each other through the communication bus 11 during the charging operation. However, the amount of charged power requires constant updating, and since there is a delay in sending the information (i.e., the amount of charged power) from the BMS 13 to the controller 14 through the communication bus 11, the information received by the controller 14 is unable to reflect the current amount of charged power.

Furthermore, measurement of electric current may contain uncertainties, and thus the amount of charged power calculated based on the charging current magnitude may be incorrect, causing the system to misinterpret the status of the electric vehicle battery 12.

### SUMMARY

Therefore, an object of the disclosure is to provide a system and a method for managing vehicle charging that can alleviate at least one of the drawbacks of the prior art.

According to an aspect of the disclosure, a system for managing vehicle charging adapted for a charging gun is provided. The system includes a communication bus, an electric vehicle battery, a sensor, an on board charger (OBC), and a domain controller. The electric vehicle battery is electrically connected to the communication bus and is configured to send battery status information to the communication bus. The sensor is electrically connected to the electric vehicle battery and is configured to measure a current of charge to the electric vehicle battery, and to output a first voltage and a second voltage in response to the current thus measured. The first voltage corresponds to a first current range, the second voltage corresponds to a second current range, and the second current range is greater than the first current range. The OBC is electrically connected to the electric vehicle battery and the communication bus, and is adapted to be electrically connected to the charging gun. The OBC is configured to send charger status information to the communication bus. The domain controller is electrically connected to the communication bus and is configured to determine whether the electric vehicle battery is operating normally based on the battery status information, and to determine whether the OBC is operating normally based on the charger status information. The domain controller is further configured to, when determining that both of the electric vehicle battery and the OBC are operating normally, notify the OBC through the communication bus to start charging the electric vehicle battery with electricity received from the charging gun. The domain controller is further configured to select one of the first voltage and the second voltage for calibration so as to obtain a calibrated voltage, to calculate an amount of charged power that has been charged into the electric vehicle battery during ongoing charging based on the calibrated voltage, and when determining that the amount of charged power has reached a predetermined amount, to send a stop message to the communication bus so as to notify the OBC to stop charging the electric vehicle battery.

According to another aspect of the disclosure, a method for managing vehicle charging implemented by a domain controller is provided. The domain controller is adapted for use with a communication bus and a sensor. The sensor measures a current of charge to an electric vehicle battery and outputs a first voltage and a second voltage in response to the current thus measured. The first voltage corresponds to a first current range, the second voltage corresponds to a second current range, and the second current range is greater than the first current range. The method includes steps of, by the domain controller: receiving, through the communication bus, the battery status information and charger status information respectively from the electric vehicle battery and an on board charger (OBC); determining whether the electric vehicle battery is operating normally based on the battery status information; determining whether the OBC is operating normally based on the charger status information; when determining that both of the electric vehicle battery and the OBC are operating normally, notifying the OBC through the communication bus to start charging the electric vehicle battery with electricity received from a charging gun; selecting one of the first voltage and the second voltage for calibration so as to obtain a calibrated voltage; calculating an amount of charged power that has been charged into the electric vehicle battery during ongoing charging based on the calibrated voltage; and when determining that the amount of charged power has reached a predetermined amount, sending a stop message to the communication bus so as to notify the OBC to stop charging the electric vehicle battery.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a conventional system for managing vehicle charging.

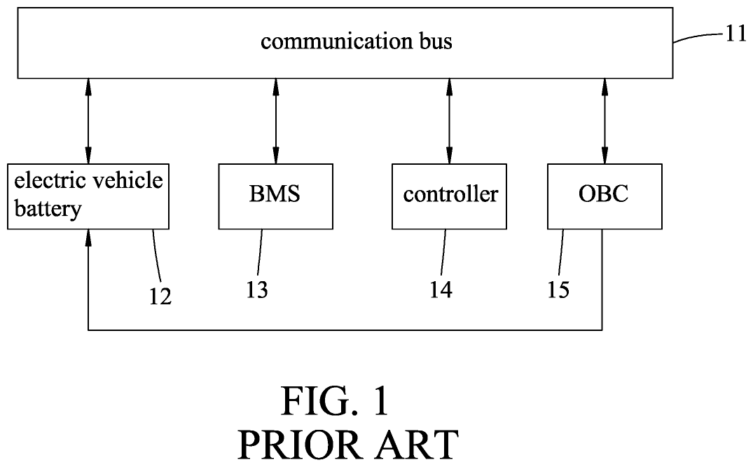

FIG. 2 is a block diagram illustrating a system for managing vehicle charging according to a first embodiment of the disclosure.

FIG. 3 is a block diagram illustrating the system for managing vehicle charging according to a second embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

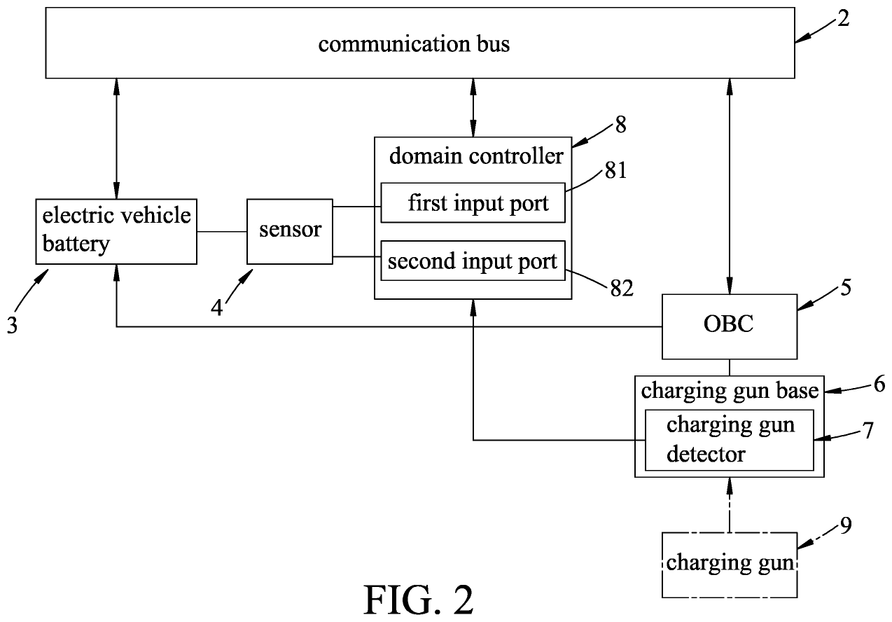

Referring to FIG. 2, a system for managing vehicle charging according to a first embodiment of the disclosure is adapted for a charging gun 9. The system includes a communication bus 2, an electric vehicle battery 3, a sensor 4, an on board charger (OBC) 5, a charging gun base 6, a charging gun detector 7, and a domain controller 8.

In some embodiments, the communication bus 2 may be realized as a Controller Area Network bus (CAN bus) and act as a network for exchanging information between various controllers and/or sensors of an electric vehicle. Since the CAN bus is a standard bus for electric vehicles, it will not be described in further detail for the sake of brevity.

The electric vehicle battery 3 is electrically connected to the communication bus 2 and is configured to send battery status information to the communication bus 2. In this embodiment, the electric vehicle battery 3 is a high voltage battery, and the battery status information may include battery operating status (e.g., operating normally or not), cell temperature, cell voltage, cell current, etc.

The sensor 4 is electrically connected to the electric vehicle battery 3, and is configured to measure a current of charge/discharge to the electric vehicle battery 3, and to output a first voltage and a second voltage in response to the current thus measured. The first voltage is detected from a first channel of the sensor 4, and corresponds to a first current range. The second voltage is detected from a second channel of the sensor 4, and corresponds to a second current range, and the second current range is greater than the first current range. In this embodiment, the sensor 4 is a current sensor, and is electrically connected to the domain controller 8 so that the first voltage and the second voltage are outputted by the sensor 4 directly to the domain controller 8. In one example, the first current range is from −30 A to +30 A, the second current range is from −350 A to +350 A, and the first voltage and the second voltage both range from 0V to 10V. To describe in further detail, when the sensor 4 measures the current of charge/discharge to the electric vehicle battery 3, the sensor 4 simultaneously outputs the first voltage and the second voltage for the domain controller 8 to convert the first voltage and the second voltage into current values. When the current of charge/discharge is within the range of −30 A to +30 A, the current value converted from the first voltage would be more precise in comparison to the current value converted from the second voltage. When the current of charge/discharge is not within the range of −30 A to +30 A (i.e., above +30 A or below −30 A), the current value converted from the second voltage would be more accurate in comparison to the current value converted from the first voltage. It should be noted that the abovementioned values are merely examples and the disclosure is not limited to such.

The OBC 5 is electrically connected to the electric vehicle battery 3 and the communication bus 2, and is adapted to be electrically connected to the charging gun 9. The OBC 5 is configured to send charger status information to the communication bus 2. In this embodiment, the OBC 5 is configured to switch between a sleep mode and an operating mode, and the charger status information includes at least whether the OBC 5 is in the sleep mode or in the operating mode so that other components of the electric vehicle may be informed of a status of the OBC 5 through the communication bus 2.

The charging gun base 6 is adapted for receiving the charging gun 9 therein and is electrically connected to the OBC 5. When the charging gun 9 is inserted in the charging gun base 6, the charging gun 9 is electrically connected to the OBC 5 through the charging gun base 6.

The charging gun detector 7 is disposed on the charging gun base 6 and is electrically connected to the domain controller 8. The charging gun detector 7 is configured to send an inserted message to the domain controller 8 when detecting that the charging gun 9 is inserted into the charging gun base 6, so as to trigger the domain controller 8 to determine whether the electric vehicle battery 3 and the OBC 5 are operating normally. In this embodiment, the charging gun detector 7 is a trigger switch, and the inserted message is in a form of voltage, which may be at either a high level or a low level, but the disclosure is not limited to such. In some embodiments, the charging gun detector 7 may be a proximity switch or any other forms of sensor switches.

The domain controller 8 is electrically connected to the communication bus 2 and the charging gun detector 7. In this embodiment, the domain controller 8 is a microcontroller that is disposed on a circuit board (not shown), and is configured to communicate with the electric vehicle battery 3 and the OBC 5 through the communication bus 2. In this embodiment, the domain controller 8 integrates relevant functions for monitoring battery status. The domain controller 8 is capable of directly determining various problems (e.g., insulation, high voltage, low voltage) of the electric vehicle battery 3, enabling direct confirmation of the battery status so as to avoid transmission delays caused by signal handshakes between different controllers of the electric vehicle, and to avoid accidents related to overheating caused by battery abnormalities during charging. Additionally, the domain controller 8 is capable of directly monitoring statuses of various components of the electric vehicle while the electric vehicle is charging, without the need for relaying component statuses through other controller(s), thereby improving charging efficiency. Furthermore, the domain controller 8 is capable of confirming the battery status before the electric vehicle is driven, so as to avoid a risk of a driver being electrocuted due to imbalance between various cells or poor insulation of the electric vehicle battery 3. Furthermore, the domain controller 8 is capable of optimizing distribution of energy generated by a braking system when the electric vehicle moves.

The domain controller 8 is configured to, upon receiving the inserted message, determine whether the electric vehicle battery 3 is operating normally based on the battery status information, and determine whether the OBC 5 is operating normally (i.e., whether the OBC 5 is in the operating mode) based on the charger status information. In this embodiment, the electric vehicle battery 3 is operating normally when the electric vehicle battery 3 conforms to a predefined normal operating condition (e.g., the cell temperature, the cell voltage, and/or the cell current are within a predetermined range).

The domain controller 8 is configured to, when determining that the OBC 5 is in the sleep mode based on the charger status information, send a wake-up message to the communication bus 2. The OBC 5 is configured to, upon receiving the wake-up message from the domain controller 8 through the communication bus 2, switch to the operating mode (i.e., the OBC 5 is now operating normally) and update the charger status information to the communication bus 2.

The domain controller 8 is configured to, when determining that the electric vehicle battery 3 and the OBC 5 are operating normally, send a preparation message to the communication bus 2 for the OBC 5 to prepare charging. The OBC is configured to, upon receiving the preparation message from the domain controller 8 through the communication bus 2, send a prepared-for-charging message to the communication bus 2.

The domain controller 8 is configured to, upon receiving the prepared-for-charging message from the OBC 5 through the communication bus 2, notify the OBC 5 through the communication bus 2 to start charging the electric vehicle battery 3 with electricity received from the charging gun 9.

In this embodiment, the domain controller 8 includes a first input port 81 and a second input port 82 that are configured to receive the first voltage and the second voltage, respectively.

The domain controller 8 is configured to, upon receiving the prepared-for-charging message from the OBC 5 through the communication bus 2, perform a calibration procedure during which the domain controller 8 selects one of the first voltage and the second voltage for calibration before charging the electric vehicle battery 3 so as to obtain a calibrated voltage. In this embodiment, the domain controller 8 first selects the first voltage for calibration, but the disclosure is not limited to such.

To further describe the calibration procedure, before charging the electric vehicle battery 3, the domain controller 8 calculates a first offset value and a second offset value respectively based on the first voltage and the second voltage generated under a specific condition. In this embodiment, the first offset value is a deviation of the first voltage from a zero-point value of the first voltage, and the second offset value is a deviation of the second voltage from the zero-point value of the second voltage. The zero-point value is a theoretical magnitude of the first or second voltage that corresponds to the current of charge/discharge to the electric vehicle battery 3 being zero. In one example where the zero-point value of the first voltage is 5V, if the first voltage is measured to be 5.2V by the domain controller 8 when the current of charge/discharge to the electric vehicle battery 3 is zero, the first offset value would be 0.2V, and the calibrated voltage is obtained by subtracting 0.2V from the first voltage that is measured during charging, thereby calibrating the first voltage. During charging of the electric vehicle battery 3, when the domain controller 8 selects the first voltage for calibration, the calibrated voltage is obtained by subtracting the first offset value from the first voltage, and when the domain controller 8 selects the second voltage for calibration, the calibrated voltage is obtained by subtracting the second offset value from the second voltage.

The domain controller 8 is configured to calculate an amount of charged power that has been charged into the electric vehicle battery 3 during ongoing charging based on the calibrated voltage. When determining that the amount of charged power has reached a predetermined amount, the domain controller 8 sends a stop message to the communication bus 2 so as to notify the OBC 5 to stop charging the electric vehicle battery 3.

During charging of the electric vehicle battery 3, when determining that the first voltage is selected and that the calibrated voltage thus obtained is greater than a first hysteresis parameter, the domain controller 8 switches to obtain the calibrated voltage based on the second voltage instead. In addition, when determining that the second voltage is selected and that the calibrated voltage thus obtained is smaller than a second hysteresis parameter which is smaller than the first hysteresis parameter, the domain controller 8 switches to obtain the calibrated voltage based on the first voltage instead, which is more precise compared to the second voltage in representing the current of charge/discharge to the electric vehicle battery 3. In this embodiment, the first hysteresis parameter is a voltage that corresponds to the current of 28 A, and the second hysteresis parameter is a voltage that corresponds to the current of 25 A, but the disclosure is not limited to such.

The amount of charged power is calculated by the domain controller 8 based on the calibrated voltage. Specifically, since the calibrated voltage corresponds to the current of charge/discharge to the electric vehicle battery 3, the calibrated voltage may be converted to an actual current of charge/discharge to the electric vehicle battery 3 by parameter conversion, and the amount of charged power may be calculated by integrating the actual current with a period of charging time. Since the amount of charged power is directly calculated by the domain controller 8, signal transmission regarding the first voltage and the second voltage through other components of the electric vehicle is not required, so efficiency in obtaining the amount of charged power is increased. The system according to the disclosure is capable of obtaining the amount of charged power every 120 ms, which is faster compared to a conventional system that needs 250 ms to make an update on the amount of charged power.

Furthermore, since there is a gap between the first hysteresis parameter and the second hysteresis parameter, and the domain controller 8 only reobtains the calibrated voltage when the calibrated voltage is greater than the first hysteresis parameter or when the calibrated voltage is smaller than the second hysteresis parameter, the system of this disclosure may avoid rapid changes in the calibrated voltage. Unlike the conventional system which has only one threshold, the calibrated voltage may be reobtained quickly when the calibrated voltage is very close to and quickly moves back and forth relative to the threshold.

Additionally, compared to the conventional system which uses only one voltage to represent the current of charge/discharge to the electric vehicle battery, the disclosure is capable of obtaining a more precise magnitude of the current of charge/discharge to the electric vehicle battery 3 when the calibrated voltage is obtained based on the first voltage that corresponds to a smaller current range, thereby managing the charging system in a more accurate manner.

The calibration procedure allows the domain controller 8 to obtain the calibrated voltage that is more accurate in representing the current of charge/discharge to the electric vehicle battery 3 by removing the first offset value and the second offset value respectively from the first voltage and the second voltage, so the amount of charged power thus calculated may be more accurate, thus managing the charging system more accurately compared to the conventional system.

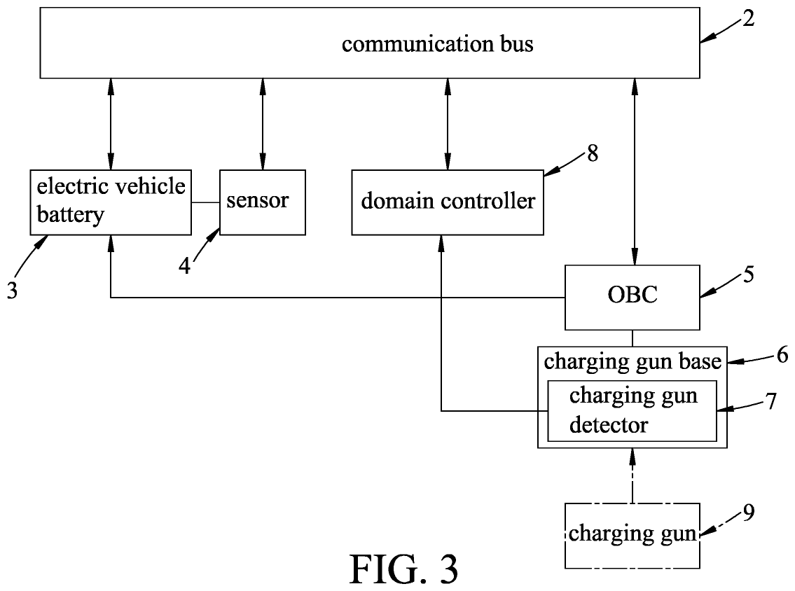

Referring to FIG. 3, the system for managing vehicle charging according to a second embodiment of the disclosure is similar to the first embodiment. Different from the first embodiment, the domain controller 8 in the second embodiment does not include the first input port 81 and the second input port 82 (as in FIG. 2). The sensor 4 is electrically connected to the communication bus 2, and the first voltage and the second voltage are outputted by the sensor 4 to the domain controller 8 through the communication bus 2 instead of being outputted directly to the domain controller 8 as in the first embodiment. As such, the second embodiment delivers the same function as the first embodiment.

In summary, the domain controller 8 of the disclosure is capable of calculating the amount of charged power rapidly, and is capable of accurately assessing the amount of charged power by virtue of the sensor 4 that outputs the first voltage and the second voltage in response to the measured current of charge/discharge to the electric vehicle battery 3.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A system for managing vehicle charging adapted for a charging gun, said system comprising:
a communication bus;
an electric vehicle battery electrically connected to said communication bus and configured to send battery status information to said communication bus;
a sensor electrically connected to said electric vehicle battery, and configured to measure a current of charge to said electric vehicle battery, and to output a first voltage and a second voltage in response to the current thus measured, where the first voltage corresponds to a first current range, the second voltage corresponds to a second current range, and the second current range is greater than the first current range;
an on board charger (OBC) electrically connected to said electric vehicle battery and said communication bus, and adapted to be electrically connected to the charging gun, said OBC being configured to send charger status information to said communication bus; and
a domain controller electrically connected to said communication bus and configured to:
determine whether said electric vehicle battery is operating normally based on the battery status information,
determine whether said OBC is operating normally based on the charger status information,
when determining that both of said electric vehicle battery and said OBC are operating normally, notify said OBC through said communication bus to start charging said electric vehicle battery with electricity received from the charging gun,
select one of the first voltage and the second voltage for calibration so as to obtain a calibrated voltage,
calculate an amount of charged power that has been charged into said electric vehicle battery during ongoing charging based on the calibrated voltage, and
when determining that the amount of charged power has reached a predetermined amount, send a stop message to said communication bus so as to notify said OBC to stop charging said electric vehicle battery.

2. The system as claimed in claim 1, further comprising:
a charging gun base adapted for receiving the charging gun therein and electrically connected to said OBC; and
a charging gun detector disposed on said charging gun base and electrically connected to said domain controller, said charging gun detector being configured to send an inserted message to said domain controller when detecting that said charging gun is inserted into said charging gun base, so as to trigger said domain controller to determine whether said electric vehicle battery and said OBC are operating normally.

3. The system as claimed in claim 2, wherein:
said domain controller is configured to, when determining that said OBC is in a sleep mode based on the charger status information, send a wake-up message to said communication bus; and
said OBC is configured to, upon receiving the wake-up message from said domain controller through said communication bus, switch to an operating mode and update the charger status information to said communication bus.

4. The system as claimed in claim 3, wherein:
said domain controller is configured to, when determining that said electric vehicle battery and said OBC are operating normally, send a preparation message to said communication bus; and
said OBC is configured to, upon receiving the preparation message from said domain controller through said communication bus, send a prepared-for-charging message to said communication bus.

5. The system as claimed in claim 4, wherein:
said domain controller is configured to, upon receiving the prepared-for-charging message from said OBC through said communication bus, perform a calibration procedure during which said domain controller calculates a first offset value and a second offset value respectively based on the first voltage and the second voltage,
said domain controller is configured to, when selecting the first voltage for calibration, obtain the calibrated voltage by subtracting the first offset value from the first voltage, and
said domain controller is configured to, when selecting the second voltage for calibration, obtain the calibrated voltage by subtracting the second offset value from the second voltage.

6. The system as claimed in claim 5, wherein:
said domain controller includes a first input port and a second input port that are configured to receive the first voltage and the second voltage respectively; and
said domain controller is configured to:
select said one of the first voltage and the second voltage for calibration before charging said electric vehicle battery so as to obtain the calibrated voltage,
when determining that the first voltage is selected and that the calibrated voltage thus obtained is greater than a first hysteresis parameter, switch to obtain the calibrated voltage based on the second voltage instead, and
when determining that the second voltage is selected and that the calibrated voltage thus obtained is smaller than a second hysteresis parameter which is smaller than the first hysteresis parameter, switch to obtain the calibrated voltage based on the first voltage instead.

7. The system as claimed in claim 6, wherein said sensor is electrically connected to said domain controller, and the first voltage and the second voltage are outputted by said sensor directly to said domain controller.

8. The system as claimed in claim 5, wherein said sensor is electrically connected to said communication bus, and the first voltage and the second voltage are outputted by said sensor to said domain controller through said communication bus.

9. A method for managing vehicle charging, implemented by a domain controller that is adapted for use with a communication bus and a sensor, the sensor measuring a current of charge to an electric vehicle battery and outputting a first voltage and a second voltage in response to the current thus measured, where the first voltage corresponds to a first current range, the second voltage corresponds to a second current range, and the second current range is greater than the first current range,
said method comprising, by the domain controller:
receiving, through the communication bus, the battery status information and charger status information respectively from the electric vehicle battery and an on board charger (OBC);
determining whether the electric vehicle battery is operating normally based on the battery status information;
determining whether the OBC is operating normally based on the charger status information;
when determining that both of the electric vehicle battery and the OBC are operating normally, notifying the OBC through the communication bus to start charging the electric vehicle battery with electricity received from a charging gun;
selecting one of the first voltage and the second voltage for calibration so as to obtain a calibrated voltage;
calculating an amount of charged power that has been charged into the electric vehicle battery during ongoing charging based on the calibrated voltage; and
when determining that the amount of charged power has reached a predetermined amount, sending a stop message to the communication bus so as to notify the OBC to stop charging the electric vehicle battery.

10. The method as claimed in claim 9, further comprising, when determining that the electric vehicle battery and the OBC are operating normally, the domain controller sending a preparation message to the communication bus for the OBC to prepare charging.

11. The method as claimed in claim 10, further comprising, upon receiving a prepared-for-charging message through the communication bus that is sent by the OBC in response to the preparation message, the domain controller performing a calibration procedure by:
calculating a first offset value and a second offset value respectively based on the first voltage and the second voltage,
when the domain controller selects the first voltage for calibration, obtaining the calibrated voltage by subtracting the first offset value from the first voltage, and
when the domain controller selects the second voltage for calibration, obtaining the calibrated voltage by subtracting the second offset value from the second voltage.

12. The method as claimed in claim 11, the domain controller including a first input port and a second input port that are configured to receive the first voltage and the second voltage respectively, the method further comprising, by the domain controller:
selecting said one of the first voltage and the second voltage for calibration before charging the electric vehicle battery so as to obtain the calibrated voltage;
when determining that the first voltage is selected and that the calibrated voltage thus obtained is greater than a first hysteresis parameter, switching to obtain the calibrated voltage based on the second voltage instead; and
when determining that the second voltage is selected and that the calibrated voltage thus obtained is smaller than a second hysteresis parameter which is smaller than the first hysteresis parameter, switching to obtain the calibrated voltage based on the first voltage instead.
